(19) United States
(12) Patent Application Publication
(10) Pub. No.: US 2023/0195420 A1
(43) Pub. Date: Jun. 22, 2023

(54) FLOATING-POINT COMPUTATION APPARATUS AND METHOD USING COMPUTING-IN-MEMORY

(71) Applicant: Korea Advanced Institute of Science and Technology, Daejeon (KR)

(72) Inventors: Hoi Jun YOO, Daejeon (KR); Ju Hyoung LEE, Daejeon (KR)

(73) Assignee: Korea Advanced Institute of Science and Technology, Daejeon (KR)

(21) Appl. No.: 17/741,509

(22) Filed: May 11, 2022

(30) Foreign Application Priority Data
Dec. 21, 2021 (KR) 10-2021-0183937

(51) Int. Cl. G06F 7/544; G06F 7/487; G06F 7/485; G06F 7/499; G06F 5/01; G06N 3/04

(52) U.S. Cl. CPC G06F 7/5443; G06F 7/4876; G06F 7/485; G06F 7/49915; G06F 5/012; G06N 3/04

(57) ABSTRACT

Disclosed herein are a floating-point computation apparatus and method using Computing-in-Memory (CIM). The floating-point computation apparatus performs a multiply-and-accumulation operation on pieces of input neuron data represented in a floating-point format, and includes a data preprocessing unit configured to separate and extract an exponent and a mantissa from each of the pieces of input neuron data, an exponent processing unit configured to perform CIM on input neuron exponents, which are exponents separated and extracted from the input neuron data, and a mantissa processing unit configured to perform a high-speed computation on input neuron mantissas, separated and extracted from the input neuron data, wherein the exponent processing unit determines a mantissa shift size for a mantissa computation and transfers the mantissa shift size to the mantissa processing unit, and the mantissa processing unit normalizes a result of the mantissa computation and transfers a normalization value to the exponent processing unit.

### CROSS REFERENCE TO RELATED APPLICATION(S)

This application claims the benefit of Korean Patent Application No. 10-2021-0183937, filed 2021 Dec. 21, which is hereby incorporated by reference in its entirety into this application.

### BACKGROUND OF THE INVENTION

### 1. Technical Field

The present invention relates generally to a floating-point computation apparatus and method, and more particularly to a floating-point computation apparatus and method using Computing-in-Memory, which compute data represented in a floating-point format (hereinafter referred to as “floating-point data”) using Computing-in-Memory, thus improving the energy efficiency of a floating-point computation processor required for deep neural network training.

### 2. Description of the Related Art

Since a deep neural network shows the best performance in various signal-processing fields, such as those of image classification and recognition and speech recognition, the use thereof is essentially required.

Because a process for training such a deep neural network must represent all values ranging from errors and gradients, each having a very small magnitude, to weights and neuron values, each having a relatively large magnitude, the use of floating-point computation, capable representing a wide range of values, is required.

In particular, computation in a 16-bit brain floating-point format (bfloat16) composed of one sign bit, 8 exponent bits, and 7 mantissa bits has attracted attention as an operation having high energy efficiency while maintaining the training precision of a deep neural network (Reference Document 1).

Therefore, most commercial processors (e.g., TPUv2 from Google, Armv8-A from ARM, Nervana from Intel, etc.) support deep neural network training by utilizing Brain Floating-Point (BFP) multiplication and a 32-bit FP (FP32) accumulation (Reference Document 2).

Also, for training a deep neural network, a deep neural network (DNN) accelerator must repeat processes of reading weights and neuron values stored in a memory, performing operations thereon, and then storing the results of the operation in the memory. Due thereto, a problem may arise in that the amount of power consumed by the memory is increased.

Meanwhile, recently, as a method for reducing power consumption by memory, Computing-in-Memory (CIM) has been highlighted. Computing-in-Memory (CIM) is characterized in that computation is performed in or near a memory, thus reducing the number of accesses to memory or enabling memory access with high energy efficiency.

Therefore, existing processors which utilize the characteristics of CIM can achieve the highest level of energy efficiency by reducing power consumption required for memory access (Reference Document 3 and Reference Document 4).

However, most existing CIM processors are limited in that they are specific for fixed-point computation (operations) and do not support floating-point computation.

The reason for this is that fixed-point computation uniformly represents a given range using a predefined number of bits and the fixed position of a decimal point, whereas floating-point computation includes a sign bit, exponent bits, and mantissa bits, and dynamically represents a given range depending on the exponent. That is, in the case of floating-point computation, it is very difficult to simultaneously optimize an exponent computation and a mantissa computation using a CIM processor due to the heterogeneity thereof because the exponent computation requires only simple addition or subtraction and the mantissa computation additionally requires complicated operations such as multiplication, bit shifting, or normalization.

In practice, when a floating-point multiplier-accumulator is implemented through a conventionally proposed CIM processor, a delay time ranging from several hundreds of cycles to several thousands of cycles is taken, and thus the floating-point multiplier-accumulator is not suitable for high-speed and energy efficient computations, as is required by a deep neural network (Reference Document 5).

That is, only a small number of operation logics can be integrated into a CIM processor due to the limited area thereof. Here, since existing CIM processors adopt a homogenous floating-point CIM architecture, a great speed reduction occurs during a process for dividing and performing a complicated mantissa computation using a simple CIM processor. For example, since a conventional CIM processor performs one Multiply-and-Accumulate (MAC) operation at a processing speed that is at least 5000 times slower than a floating-point system, which performs a brain floating-point multiplication and 32-bit floating-point accumulation, a problem arises in that it is impossible to utilize a conventional CIM processor in practice.

Recently, in edge devices for providing a user-custom function, the necessity for to train deep neural networks has come to the fore, whereby it is essential to extend the range of application of CIM processors to encompass floating-point computations in order to implement a deep neural network (DNN) training processor having higher energy efficiency.

### PRIOR ART DOCUMENTS

### Non-Patent Documents

(Non-patent Document 1) Reference Document 1: D. Kalamkar et al, “Study of BFLOAT16 for Deep Learning Training,” arXiv preprint arXiv:1905.12322, 2019.
(Non-patent Document 2) Reference Document 2: N. Burgess, J. Milanovic, N. Stephens, K. Monachopoulos and D. Mansell, “Bfloat16 Processing for Neural Networks,” 2019 IEEE 26th Symposium on Computer Arithmetic (ARITH), 2019, pp. 88-91
(Non-patent Document 3) Reference Document 3: H. Jia et al., “15.1 A Programmable Neural-Network Inference Accelerator Based on Scalable In-Memory Computing,” 2021 IEEE International Solid-State Circuits Conference (IS SCC), 2021, pp. 236-238
(Non-patent Document 4) Reference Document 4: J. Yue et al., “15.2 A 2.75-to-75.9TOPS/W Computing-in-Memory NN Processor Supporting Set-Associate Block-Wise Zero Skipping and Ping-Pong CIM with Simultaneous Computation and Weight Updating,” 2021 IEEE International Solid-State Circuits Conference (ISSCC), 2021, pp. 238-240
(Non-patent Document 5) Reference Document 5: J. Wang et al., “A 28-nm Compute SRAM With Bit-Serial Logic/Arithmetic Operations for Programmable In-Memory Vector Computing,” in IEEE Journal of Solid-State Circuits, vol. 55, no. 1, pp. 76-86, January 2020.

### SUMMARY OF THE INVENTION

Accordingly, the present invention has been made keeping in mind the above problems occurring in the prior art, and an object of the present invention is to provide a floating-point computation apparatus and method using Computing-in-Memory (CIM), which calculate data represented in a floating-point format using Computing-in-Memory so that an exponent computation and a mantissa computation are separated from each other and so that only the exponent computation is performed by a CIM processor and the mantissa computation is performed by a mantissa processing unit, thus avoiding a processing delay occurring due to the use of Computing-in-Memory for the mantissa computation.

Another object of the present invention is to provide a floating-point computation apparatus and method using computing-in-memory, which can promptly perform floating-point computation by solving a processing delay occurring due to the need to use CIM for a mantissa computation, and can improve the energy efficiency of a deep-neural network (DNN) accelerator by reducing the amount of power consumed by memory.

A further object of the present invention is to provide a floating-point computation apparatus and method using computing-in-memory, which precharge only one local bitline by supporting in-memory AND/NOR operations during the operation of a CIM processor, and which reuse a charge if the previous value of a global bitline is identical to the current value of the global bitline by adopting a hierarchical bitline structure, thus minimizing precharging, with the result that the amount of power consumed in order to access an exponent stored in memory can be reduced.

Yet another object of the present invention is to provide a floating-point computation apparatus and method using computing-in-memory, which derive sparsity patterns of input neurons that are input to a CIM processor and a mantissa processing unit and thereafter skip computation on an input neuron, the sparsity pattern of which has a value of ‘0’, thus accelerating the entire DNN computation.

Still another object of the present invention is to provide a floating-point computation apparatus and method using computing-in-memory, which skip a normalization process in an intermediate stage occurring during a mantissa computation process and perform normalization only in a final stage, thereby reducing power consumption and speed reduction attributable to communication between a CIM processor for performing an exponent computation and a mantissa processing unit for performing a mantissa computation, and which shorten the principal path of the mantissa processing unit, thereby reducing the amount of space and power consumed by the mantissa processing unit without decreasing computation precision.

In accordance with an aspect of the present invention to accomplish the above objects, there is provided a floating-point computation apparatus for performing a Multiply-and-Accumulation (MAC) operation on a plurality of pieces of input neuron data represented in a floating-point format, the floating-point computation apparatus including a data preprocessing unit configured to separate and extract an exponent and a mantissa from each of the pieces of input neuron data; an exponent processing unit configured to perform Computing-in-Memory (CIM) on input neuron exponents, which are exponents separated and extracted from the pieces of input neuron data; and a mantissa processing unit configured to perform a high-speed computation on input neuron mantissas, which are mantissas separated and extracted from the pieces of input neuron data, wherein the exponent processing unit determines a mantissa shift size for a mantissa computation and transfers the mantissa shift size to the mantissa processing unit, and wherein the mantissa processing unit normalizes a result of the mantissa computation and thereafter transfers a normalization value generated as a result of normalization to the exponent processing unit.

In accordance with another aspect of the present invention to accomplish the above objects, there is provided a floating-point computation method for performing a multiply-and-accumulation operation on a plurality of pieces of input neuron data represented in a floating-point format using a floating-point computation apparatus that includes an exponent processing unit for an exponent computation in the floating-point format and a mantissa processing unit for a mantissa computation in the floating point format, the floating-point computation method including a data preprocessing operation of separating and extracting an exponent and a mantissa from each of the pieces of input neuron data; an exponent computation operation of performing, by the exponent processing unit, computing-in-memory (CIM) on input neuron exponents, which are exponents separated and extracted in the data preprocessing operation; and a mantissa computation operation of performing, by the mantissa processing unit, a high-speed computation on input neuron mantissas, which are mantissas separated and extracted in the data preprocessing operation, wherein the exponent computation operation includes determining a mantissa shift size for the mantissa computation and transferring the mantissa shift size to the mantissa processing unit, and wherein the mantissa computation operation includes normalizing a result of the mantissa computation and thereafter transferring a normalization value generated as a result of normalization to the exponent processing unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram of a floating-point computation apparatus according to an embodiment of the present invention;

FIG. 2 is a schematic block diagram of an exponent processing unit according to an embodiment of the present invention;

FIG. 3 is a schematic block diagram of an exponent computation memory according to an embodiment of the present invention;

FIG. 4 is a schematic block diagram of a Computing-in-Memory (CIM) local array according to an embodiment of the present invention;

FIG. 5 is a CIM truth table according to an embodiment of the present invention;

FIG. 6 is a global bitline computation truth table according to an embodiment of the present invention;

FIG. 7 is a diagram for explaining pipelined operations of respective CIM local arrays according to an embodiment of the present invention;

FIG. 8 is a schematic block diagram of an exponent peripheral circuit according to an embodiment of the present invention;

FIG. 9 is a schematic block diagram of a mantissa processing unit according to an embodiment of the present invention;

FIG. 10 is a schematic block diagram of a mantissa computation unit according to an embodiment of the present invention; and

FIGS. 11 to 14 are processing flowcharts of a floating-point computation method according to an embodiment of the present invention.

### DESCRIPTION OF THE PREFERRED EMBODIMENTS

Hereinafter, embodiments of the present invention will be described in detail with reference to the attached drawings. The present invention will be described in detail such that those skilled in the art to which the present invention pertains can easily practice the present invention. The present invention may be embodied in various different forms, and is not limited to the following embodiments. Meanwhile, in the drawings, parts irrelevant to the description of the invention will be omitted so as to clearly describe the present invention. It should be noted that the same or similar reference numerals are used to designate the same or similar components throughout the drawings. Descriptions of known configurations which allow those skilled in the art to easily understand the configurations will be omitted below.

In the specification and the accompanying claims, when a certain element is referred to as “comprising” or “including” a component, it does not preclude other components, but may further include other components unless the context clearly indicates otherwise.

FIG. 1 is a schematic block diagram of a floating-point computation apparatus according to an embodiment of the present invention. Referring to FIG. 1, the floating-point computation apparatus according to the embodiment of the present invention is an apparatus for processing a Multiply-and-Accumulate (MAC) operation on a plurality of pieces of input neuron data represented in a floating-point format so that an exponent part and a mantissa part of each of the pieces of input neuron data are separated from each other, Computing-in-Memory (CIM) is performed on the exponent part, and high-speed digital computation is performed on the mantissa part. The floating-point computation apparatus includes a data preprocessing unit 100, an exponent processing unit 200, and a mantissa processing unit 300.

The data preprocessing unit 100 separates and extracts an exponent part and a mantissa part from each of the pieces of input neuron data. That is, the data preprocessing unit 100 generates at least one input neuron data pair by pairing the plurality of pieces of input neuron data that are sequentially received for a Multiply-and-Accumulate (MAC) operation depending on the sequence thereof, and separates and extracts an exponent part and a mantissa part from each of arbitrary first and second input neuron data, forming the corresponding input neuron data pair, in each preset cycle. Also, the data preprocessing unit 100 transfers the separated and extracted exponent parts (hereinafter referred to as ‘first and second input neuron exponents’) to the exponent processing unit 200, and transfers the separated and extracted mantissa parts (hereinafter referred to as ‘first and second input neuron mantissas’) to the mantissa processing unit 300.

The exponent processing unit 200 calculates the exponents separated and extracted from the pieces of input neuron data (hereinafter referred to as ‘input neuron exponents’) so that Computing-in-Memory (CIM) is performed on the first and second input neuron exponents transferred from the data preprocessing unit 100.

The mantissa processing unit 300 calculates the mantissas separated and extracted from the pieces of input neuron data (hereinafter referred to as ‘input neuron mantissas’) so that high-speed digital computation is performed on the first and second input neuron mantissas transferred from the data preprocessing unit 100.

Meanwhile, the exponent processing unit 200 determines a mantissa shift size required for the mantissa computation and transfers the mantissa shift size to the mantissa processing unit 300. The mantissa processing unit 300 must normalize the results of the mantissa computation and transmit a normalization value generated as a result of the normalization to the exponent processing unit 200.

Further, the exponent processing unit 200 determines the final exponent value based on the normalization value, receives the results of the mantissa computation from the mantissa processing unit 300, and outputs the final computation result.

As illustrated in FIG. 1, the present invention separately performs computations by separating exponents from mantissas, and utilizes a computing-in-memory (CIP) processor only for an exponent computation, thus accelerating floating-point computation with high-speed and high-energy efficiency.

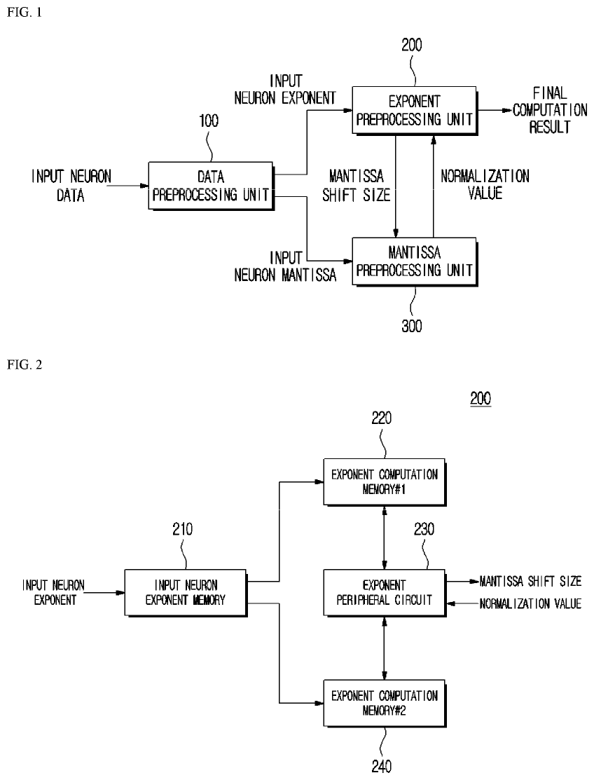

FIG. 2 is a schematic block diagram of an exponent processing unit according to an embodiment of the present invention. Referring to FIGS. 1 and 2, the exponent processing unit 200 according to the embodiment of the present invention includes an input neuron exponent memory 210, one or more exponent computation memories (exponent computation memory #1 220 and exponent computation memory #2 240), and an exponent peripheral circuit 230.

The input neuron exponent memory 210 stores input neuron exponents that are transferred from the data preprocessing unit 100 in each preset operation cycle. Here, the input neuron exponent memory 210 sequentially stores pairs of the first and second input neuron exponents transferred from the data preprocessing unit 100.

Each of the one or more exponent computation memories (exponent computation memory #1 220 and exponent computation memory #2 240) sequentially performs Computing-in-Memory (CIP) on the first and second input neuron exponent pairs received from the input neuron exponent memory 210, wherein computing-in-memory is performed in a bitwise manner and the results thereof are output. Although, in FIG. 1, an example in which two exponent computation memories (exponent computation memory #1 220 and exponent computation memory #2 240) are included is illustrated, the number of exponent computation memories according to the present invention is not limited based on the example of FIG. 2. That is, the floating-point computation apparatus according to the present invention may further include two or more exponent computation memories.

Further, each of the one or more exponent computation memories (exponent computation memory #1 220 and exponent computation memory #2 240) may be any one of a weight exponent computation memory, which stores the exponent of a weight generated in a DNN training process (hereinafter referred to as a ‘weight exponent’) and performs computing-in-memory on the corresponding input neuron exponent and the weight exponent, and an output neuron exponent computation memory, which stores the exponent of output neuron data generated in the DNN training process (hereinafter referred to as an ‘output neuron exponent’) and performs computing-in-memory on the input neuron exponent and the output neuron exponent.

The exponent peripheral circuit 230 processes the results of computing-in-memory transferred from the exponent computation memories 220 and 240 and then outputs the final results. That is, the exponent peripheral circuit 230 sequentially calculates the sums of the first and second input neuron exponent pairs transferred from the exponent computation memory 220 or 240, sequentially compares the sums of the first and second input neuron exponent pairs with each other, determines the difference between the sums to be the mantissa shift size, and updates and stores a maximum exponent value.

For example, when an input neuron exponent pair (A1 and B1) is input to the exponent computation memory 220 at arbitrary time T and another input neuron exponent pair (A2, B2) is sequentially input to the exponent computation memory 220 at time (T+1), corresponding to the subsequent operation cycle, the exponent computation memory 220 sequentially calculates the sum S1 of the input neuron exponent pair (A1, B1) and the sum S2 of the input neuron exponent pair (A2, B2) and transfers the calculated sums S1 and S2 to the exponent peripheral circuit 230. The exponent peripheral circuit 230 compares the values S1 and S2 with each other, determines the difference between the values S1 and S2 to be the mantissa shift size, and updates and stores the maximum exponent value, which is a comparison value at time (T+2) corresponding to the subsequent operation cycle, with a larger one of the two values S1 and S2.

Meanwhile, the exponent peripheral circuit 230 may be shared by the one or more exponent computation memories (exponent computation memory #1 220 and exponent computation memory #2 240).

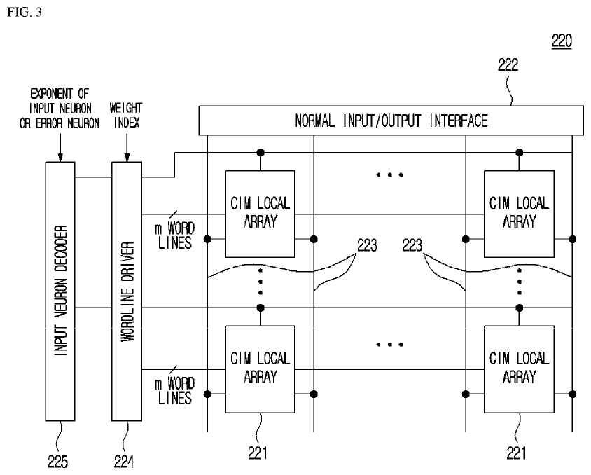

FIG. 3 is a schematic block diagram of an exponent computation memory according to an embodiment of the present invention. Referring to FIGS. 2 and 3, the exponent computation memory 220 according to the embodiment of the present invention includes a plurality of CIM local arrays 221, a normal input/output interface 222, global bitlines/global bitline bars 223, a wordline driver 224, and an input neuron decoder 225.

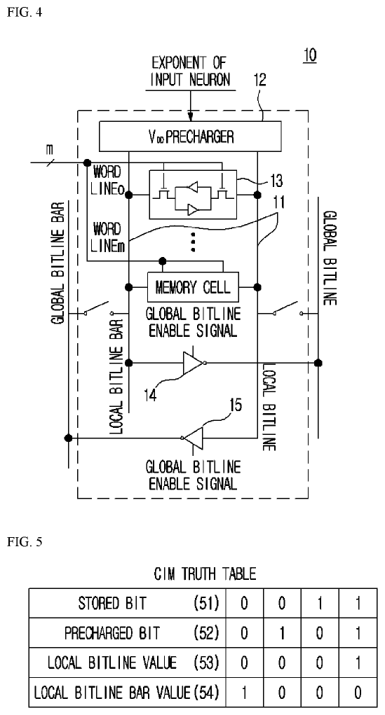

The CIM local arrays 221 each include a plurality of memory cells, and are arranged in an a×b arrangement to perform local CIM. The architecture of the CIM local arrays 221 is illustrated in FIG. 4, which will be described later.

The normal input/output interface 222 provides an interface for reading/writing data from/to each of the plurality of CIM local arrays. Here, the normal input/output interface 222 provides an interface for inputting input neuron exponents to be stored in the CIM local arrays 221 for Computing-in-Memory (CIM).

The global bitlines/global bitline bars 223 form paths for moving respective results of computing-in-memory by the plurality of CIM local arrays 221 to the exponent peripheral circuit 230. In this way, in order to move the results of computing-in-memory through the global bitlines/global bitline bars 223, a large amount of energy for charging the global bitlines/global bitline bars 223 is required, but the amount of energy may be reduced by reusing global bitline charge, which will be described later.

The wordline driver 224 generates a wordline driving signal to be transferred to the CIM local arrays 221. Here, the wordline driver 224 generates the wordline driving signal with reference to an input weight index. That is, the wordline driver 224 generates the wordline driving signal for selecting an operating memory cell from among the plurality of memory cells included in each CIM local array 221 in such a way as to generate a high wordline voltage in a write mode and a low wordline voltage in a read mode.

In particular, the wordline driver 224 must output a low wordline voltage V_{WL} as a suitably low value in order to operate the memory cells in the read mode. The reason for this is that, when the low wordline voltage V_{WL} is excessively low, a second input neuron exponent (e.g., a weight exponent) stored in the memory cells of the CIM local arrays 221 for computing-in-memory is not reflected, and when the low wordline voltage V_{WL} is excessively high, a first input neuron exponent, precharged in local bitlines and local bitline bars as will be described later, is not reflected. Therefore, it is preferable that the wordline driver 224 determines the low wordline voltage V_{WL} to be within the range represented by the following Equation (1) and then output the low wordline voltage V_{WL}. Here, the second input neuron exponent is one of the operands for computing-in-memory.

Vₜₕ≤V_{TTZ}≤V_{NML}+Vₜₕ (1)

Here, V_{NML} is a low noise margin for first and second drivers, which will be described later, and Vₜₕ is the threshold voltage of an NMOS access transistor in each memory cell.

The input neuron decoder 225 decodes the exponent value of an input neuron or an error neuron. In particular, the input neuron decoder 225 analyzes the first and second input neuron exponents, which are the targets of computing-in-memory, and performs control such that operations are performed by selecting the bitline in which the first input neuron exponent is to be charged and the memory cell in which the second input neuron exponent is to be stored.

FIG. 4 is a schematic block diagram of a Computing-in-Memory (CIM) local array according to an embodiment of the present invention. Referring to FIGS. 2 to 4, a CIM local array 221 or 10 according to an embodiment of the present invention includes a local bitline/local bitline bar 11, a V_{DD} precharger 12, a plurality of memory cells 13, a first driver 14, and a second driver 15.

A first input neuron exponent, which is the other one of the operands for computing-in-memory, is precharged in the local bitline/local bitline bar 11.

The V_{DD} precharger 12 precharges the local bitline/the local bitline bar 11 based on the bit value of the first input neuron exponent. Here, the V_{DD} precharger 12 receives the bit of the first input neuron exponent and precharges the local bitline/local bitline bar 11 in such a way that, when the corresponding bit is ‘0’, the local bitline is precharged to ‘0’ and the local bitline bar is precharged to ‘1’, and when the corresponding bit is ‘1’, the local bitline is precharged to ‘1’ and the local bitline bar is precharged to ‘0’. In a normal data read mode, both the local bitline and the local bitline bar must be precharged to ‘1’, but the present invention is advantageous in that, as described above, only one of the two bitlines needs to be precharged depending on the bit value of the input neuron exponent, thus reducing power consumption.

Each memory cell 13 stores the second input neuron exponent in a bitwise manner, performs computing-in-memory on the second input neuron exponent and the first input neuron exponent precharged in the local bitline/local bitline bar 11, and then determines the bit values of the local bitline/local bitline bar 11. For this operation, each memory cell 13 may be implemented in a 6 T SRAM bit cell structure using six transistors.

Further, each memory cell 13 may be operated in one of a read mode and a write mode in response to the wordline driving signal. For example, in the write mode, the memory cell 13 stores the second input neuron exponent, which is transferred through the input/output interface 222, in a bitwise manner, and in the read mode, the memory cell performs computing-in-memory on the first input neuron exponent, which is precharged in the local bitline/the local bitline bar 11, and the second input neuron exponent, which is stored in a bitwise manner, and then determines the bit values of the local bitline/the local bitline bar 11. In this case, the value of the local bitline is determined by performing an AND operation on the first input neuron exponent and the second input neuron exponent in a bitwise manner, and the value of the local bitline bar is determined by performing a NOR operation on the first input neuron exponent and the second input neuron exponent in a bitwise manner. A truth table indicating the results of such computing-in-memory is illustrated in FIG. 5.

FIG. 5 is a Computing-in-Memory (CIM) truth table according to an embodiment of the present invention. Referring to FIG. 5, it can be seen that a local bitline value 53 is determined through an AND operation performed on a bit 51 stored in the memory cell 13 and a bit 52 precharged in the local bitline and that a local bitline bar value 54 is determined through a NOR operation performed on the bit 51 stored in the memory cell 13 and the bit 52 precharged in the local bitline.

Each of the first driver 14 and the second driver 15 drives the bit values of the local bitline/local bitline bar 11 to a global bitline/global bitline bar 223 in response to a global bitline enable signal received from outside.

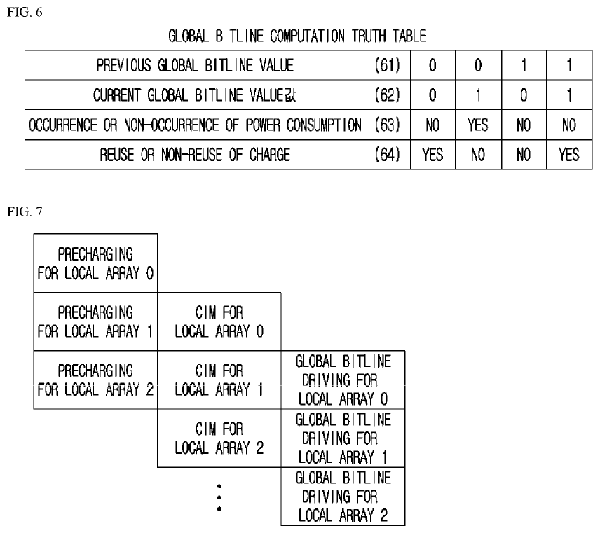

In this way, the exponent computation memory 220 according to the present invention adopts a hierarchical bitline structure, and thus the first and second drivers 14 and 15 charge and discharge the global bitline/global bitline bar 223 based on the values of the local bitline/local bitline bar 11. That is, in the exponent computation memory 220 according to the present invention, computation between the plurality of CIM local arrays 221 is determined depending on a previous global bitline value and a current global bitline value, and a truth table for such global bitline computation is exemplified in FIG. 6.

FIG. 6 is a global bitline computation truth table according to an embodiment of the present invention, which indicates whether power consumption occurs (63) (i.e., occurrence or non-occurrence of power consumption) and whether a charge is reused (64) (i.e., reuse or non-reuse of charge) depending on a previous global bitline value 61 and a current global bitline value 62. Referring to FIG. 6, when the previous global bitline value 61 is identical to the current global bitline value 62, the first and second drivers 14 and 15 reuse charge thereof, rather than recharging the global bitline, thus reducing power consumption.

Meanwhile, each of the CIM local arrays 221 sequentially performs a precharge process using the V_{DD} precharger 12, a computing-in-memory process on each of the plurality of memory cells 13, and a driving process using each of the first and second drivers 14 and 15, and adopts a computation pipelining structure for operating different CIM local arrays in each cycle in order to prevent an operating speed from decreasing due to the sequential performance of the processes. That is, each CIM local array 221 adopts the pipelining structure in which the precharge process, the Computing-in-Memory (CIM) process, and the driving process can be pipelined to overlap each other between adjacent CIM local arrays. Therefore, a precharge process for an arbitrary n-th CIM local array, a CIM process for an (n+1)-th CIM local array, and a driving process for an (n+2)-th CIM local array may be pipelined to overlap each other. The pipelined operation between the CIM local arrays is illustrated in FIG. 7.

FIG. 7 is a diagram for explaining respective pipelined operations for CIM local arrays according to an embodiment of the present invention. In detail, FIG. 7 illustrates an example in which, in a first operation cycle, only a precharge process for local array 0 is performed, but in a second operation cycle, a precharge process for local array 1 and a CIM process for local array 0 are pipelined to overlap each other, and in a third operation cycle, a precharge process for local array 2, a CIM process for local array 1, and a driving process for local array 0 are pipelined to overlap each other.

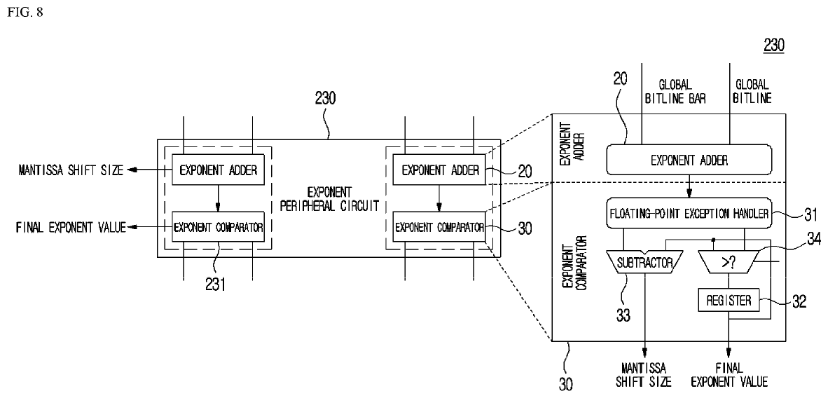

FIG. 8 is a schematic block diagram of an exponent peripheral circuit according to an embodiment of the present invention. Referring to FIGS. 2 to 8, the exponent peripheral circuit 230 according to an embodiment of the present invention includes a plurality of parallel-connected exponent computation units 231, each of which includes an exponent adder 20 and an exponent comparator 30.

When both Computing-in-Memory (CIM) and the exponent adder 20 are activated, the exponent adder 20 performs addition on exponents, receives, as inputs, the results of CIM transferred through the global bitline/global bitline bar 223, and calculates the sums of first and second input neuron exponent pairs.

The exponent comparator 30 sequentially compares the sums of the first and second input neuron exponent pairs received from the exponent adder 20 with each other, determines the difference between the sums to be a mantissa shift size, and updates and stores a maximum exponent value based on the comparison results. Here, the process for determining the mantissa shift size and updating and storing the maximum exponent value has been described above with reference to FIG. 2.

For this operation, the exponent comparator 30 may include a floating-point exception handler 31 for receiving the sums of first and second input neuron exponent pairs from the exponent adder 20 and performing exception handling in floating-point multiplication; a register 32 for storing the maximum exponent value, which is the maximum value, among the sums of first and second input neuron exponent pairs calculated during a period ranging to a previous operation cycle; a subtractor 33 for obtaining the difference between the sum of the first and second input neuron exponent pairs, output from the floating-point exception handler 31, and the maximum value stored in the register 32; and a comparator 34 for updating the maximum exponent value stored in the register 32 based on the results of subtraction by the subtractor 33, determining the mantissa shift size, and transferring the maximum exponent value and the mantissa shift size to the mantissa processing unit 300 illustrated in FIG. 1.

Here, the register 32 may determine a final exponent value by updating the maximum exponent value based on a normalization value received from the mantissa processing unit 300. That is, the register 32 may update the maximum exponent value based on the normalization value received as a result of the normalization performed only once in the last mantissa computation because preliminary normalization processing, which will be described later, is applied to the intermediate stage of the mantissa processing unit 300.

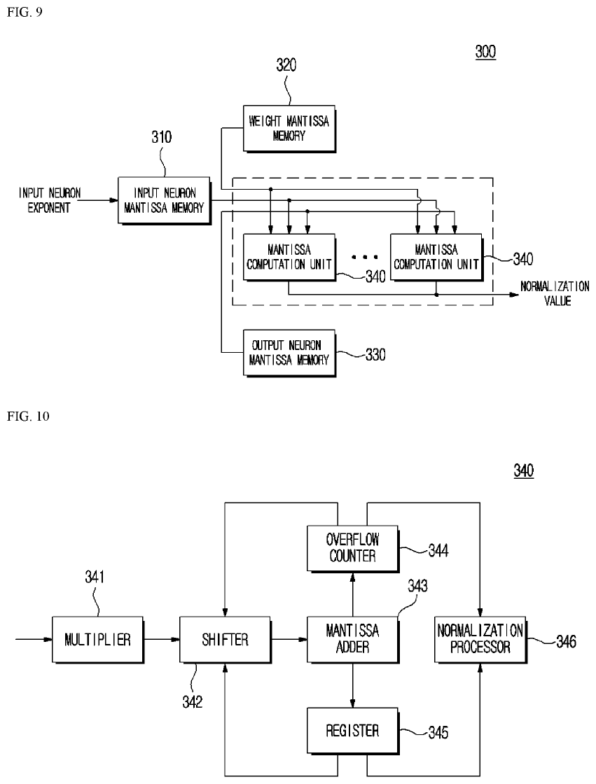

FIG. 9 is a schematic block diagram of a mantissa processing unit according to an embodiment of the present invention. Referring to FIGS. 1 and 9, the mantissa processing unit 300 according to an embodiment of the present invention may include an input neuron mantissa memory 310, a weight mantissa memory 320, an output neuron mantissa memory 330, and a plurality of mantissa computation units 340.

The input neuron mantissa memory 310 stores input neuron mantissas that are transferred from the data preprocessing unit 100 in each preset operation cycle. Here, the input neuron mantissa memory 310 sequentially stores pairs of first and second input neuron mantissas transferred from the data preprocessing unit 100.

The weight mantissa memory 320 separates only a mantissa part of a weight generated in a process of training the deep neural network (hereinafter referred to as a ‘weight mantissa part’), and separately stores the weight mantissa part.

The output neuron mantissa memory 330 separates only a mantissa part of output neuron data (hereinafter referred to as an ‘output neuron mantissa part’) generated in the process of training the deep neural network, and separately stores the output neuron mantissa part.

The plurality of mantissa computation units 340 are connected in parallel to each other, and are configured to sequentially calculate the first and second input neuron mantissa pairs and to normalize final calculation results, wherein each of the mantissa computation units 340 may calculate mantissas, received from at least one of the input neuron mantissa memory 310, the weight mantissa memory 320, and the output neuron mantissa memory 330, at high speed.

Also, each of the mantissa computation units 340 transfers the normalization value, generated as a result of normalization, to the exponent processing unit 200, thus allowing the exponent processing unit 200 to determine a final exponent value.

Here, each of the mantissa computation units 340 performs a normalization process once only after the final mantissa computation has been performed, rather than performing normalization every time addition is performed. For this, in a mantissa computation in an intermediate stage, the mantissa computation unit 340 replaces the normalization process with preliminary normalization which stores only a mantissa overflow and an accumulated value of addition results. The reason for this is to improve processing speed and reduce power consumption by reducing traffic between the exponent processing unit 200 and the mantissa processing unit 300 and simplifying a complicated normalization process.

For example, in the case of a multiply-and-accumulate operation in which 20 operands are calculated in such a way that two respective operands are paired and multiplied and the results of multiplication are accumulated, a normalization process for nine pairs, among 10 pairs, is replaced with a preliminary normalization scheme in which, after mantissa addition, accumulated mantissas are represented by a mantissa overflow counter and a mantissa accumulation value, and exponents are represented by continuously storing the maximum values obtained as results of comparisons, and the last pair, that is, the tenth pair, is calculated such that, only when the last pair is added to an existing accumulated value, a mantissa normalization and rounding-off operation and an exponent update operation depending thereon are performed once.

In this case, the precision of the preliminary normalization scheme is determined depending on the limited range of representation of accumulated mantissa values and mantissa overflow count values, and the limited range of representation thereof is determined depending on the assigned bit width. Unless the bit width of the overflow counter is sufficient, if the result of addition of mantissas falls out of the range of the maximum values of the current exponent (overflow), it is impossible to represent the addition result, thus greatly deteriorating precision. Meanwhile, unless the bit width assigned to the accumulated mantissa value is sufficient, if the result of addition of the mantissas becomes much less than values falling within the range of maximum values of the current exponent (underflow), a small portion of the result is continuously discarded, thus deteriorating the precision of computation. In the case of a 32-bit floating-point accumulation operation, when an accumulated mantissa value of 21 or more bits and an overflow counter value of three or more bits are used, preliminary normalization may be performed without causing a computation error.

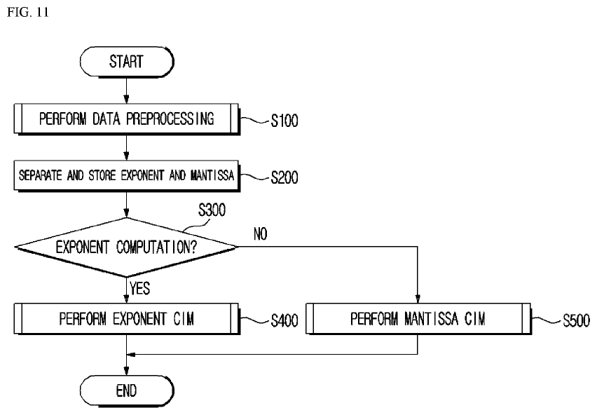

FIG. 10 is a schematic block diagram of a mantissa computation unit according to an embodiment of the present invention. Referring to FIGS. 1, 9, and 10, the mantissa computation unit 340 according to an embodiment of the present invention includes a multiplier 341, a shifter 342, a mantissa adder 343, an overflow counter 344, a register 345, and a normalization processor 346.

The multiplier 341 performs multiplication on pairs of first and second input neuron mantissas, and stores the results of the multiplication.

The shifter 342 performs shifting on the multiplication results based on the mantissa shift size transferred from the exponent processing unit 200.

The mantissa adder 343 performs addition on the one or more shifted multiplication results.

The overflow counter 344 counts a mantissa overflow occurring as a result of the addition.

The register 345 accumulates and stores the results of the addition.

The normalization processor 346 normalizes the results of the mantissa computation. Here, the normalization processor 346 is operated once only after a final mantissa computation is performed, thus performing normalization.

That is, the mantissa computation unit 340 sequentially performs the mantissa computation on all of the first and second input neuron mantissa pairs stored in the input neuron mantissa memory 310, and performs a normalization process once only for the final mantissa computation result.

For this operation, the overflow counter 344 and the register 345 transfer the mantissa overflow value and the accumulated stored value of the addition results, which are generated in the intermediate operation stage of the mantissa computation, to the shifter 342 so as to perform an operation in the subsequent stage, and transfer a mantissa overflow value and the addition result, which are generated during a mantissa computation in the final stage, to the normalization processor 346.

Due thereto, the normalization processor 346 performs normalization only on the mantissa overflow value and the addition result, which are generated during the mantissa computation in the final stage.

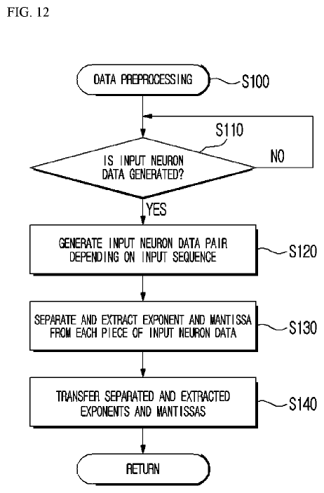

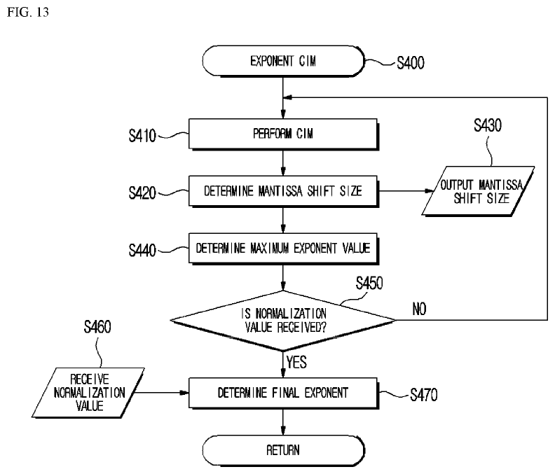

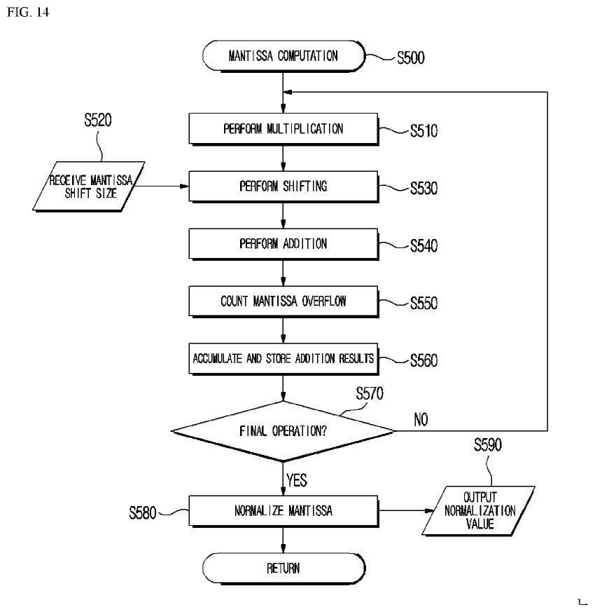

FIGS. 11 to 14 are processing flowcharts of a floating-point computation method according to an embodiment of the present invention. Referring to FIGS. 1, 11, and 14, the floating point computation method according to an embodiment of the present invention is performed as follows.

First, at step S100, the data preprocessing unit 100 performs preprocessing for a multiply-and-accumulation (MAC) operation on a plurality of pieces of input neuron data represented in a floating-point format. That is, at step S100, the data preprocessing unit 100 separates and extracts exponents and mantissas from the pieces of input neuron data.

For this, at steps S110 and S120, the data preprocessing unit 100 generates at least one input neuron data pair by pairing two or more pieces of input neuron data that are sequentially input for the MAC operation depending on the sequence thereof.

At step S130, the data preprocessing unit 100 separates and extracts an exponent and a mantissa from each of arbitrary first and second input neuron data, forming the corresponding input neuron data pair, in each preset operation cycle.

At step S140, the data preprocessing unit 100 transfers the separated and extracted exponents (hereinafter referred to as ‘first and second input neuron exponents’) to the exponent processing unit 200, and transfers the separated and extracted mantissas (hereinafter referred to as ‘first and second input neuron mantissas’) to the mantissa processing unit 300.

Here, since the detailed operation of the data preprocessing unit 100 for performing step S100 (data preprocessing) is identical to that described above with reference to FIG. 1, detailed descriptions thereof are omitted.

At step S200, exponents and mantissas preprocessed at step S100 are separated and stored. That is, at step S200, the exponent processing unit 200 and the mantissa processing unit 300 store the exponents and the mantissas, respectively, received from the data preprocessing unit 100.

At step S300, the floating-point computation apparatus checks the type of computation, and proceeds to step S400 when the type of computation is an exponent computation, otherwise proceeds to step S500.

At step S400, the exponent processing unit 200 performs Computing-in Memory (CIM) on the exponents separated and extracted at step S100 (hereinafter referred to as ‘input neuron exponents’).

For this operation, at step S410, the exponent processing unit 200 sequentially calculates the first and second input neuron exponent pairs that are transferred in each operation cycle so that computing-in-memory is performed in a bitwise manner and the sums of the first and second input neuron exponent pairs are calculated.

At step S420, the exponent processing unit 200 sequentially compares the sums of the first and second input neuron exponent pairs, which are sequentially calculated at step S410, with each other, and determines the difference between the sums to be a mantissa shift size. At step S430, the exponent processing unit 200 transfers the determined mantissa shift size to the mantissa processing unit 300.

At step S440, the exponent processing unit 200 determines a larger one of the sums of the first and second input neuron exponent pairs as a result of the sequential comparison to be the maximum exponent value.

At step S450, the exponent processing unit 200 determines whether a normalization value is received from the mantissa processing unit 300, and repeats steps S410 to S440 until the normalization value is received.

Meanwhile, at step S460, when a normalization value is received from the mantissa processing unit 300, the exponent processing unit 200 determines a final exponent based on the received normalization value at step S470.

Here, since the detailed operation of the exponent processing unit 200 for performing step S400 (exponent computation) is identical to that described above with reference to FIGS. 1 to 8, detailed descriptions thereof will be omitted.

At step S500, the mantissa processing unit 300 performs high-speed computation on the mantissas separated and extracted at step S100 (hereinafter referred to as ‘input neuron mantissas’).

For this operation, at step S510, the mantissa processing unit 300 sequentially calculates the first and second input neuron mantissa pairs that are generated in each operation cycle so that multiplication on the first and second input neuron mantissa pairs is calculated.

At step S520, when a mantissa shift size is received from the exponent processing unit 200, the mantissa processing unit 300 performs shifting on the results of the multiplication, calculated at step S510, at step S530. That is, the decimal point of the mantissa is shifted by the mantissa shift size.

At step S540, the mantissa processing unit 300 performs addition on the one or more shifted multiplication results.

At step S550, the, mantissa processing unit 300 counts a mantissa overflow value generated as a result of the addition at step S540, and at step S560, the mantissa processing unit 300 accumulates and stores the results of the addition at step S540.

At step S570, the mantissa processing unit 300 performs a final operation determination step of determining whether a mantissa computation has been finally performed on all of first and second input neuron mantissa pairs received at step S140, and repeats steps S510 to S560 until the final operation step is completed, thus sequentially performing the mantissa computation on all of the first and second input neuron mantissa pairs received at step S140.

Here, at step S530, preliminary normalization may be performed on the multiplication results at step S510 based on the mantissa overflow value, which is generated in the intermediate operation stage that is an operation stage before the final operation stage is performed, that is, the mantissa overflow value counted at step S550, and the accumulated and stored value of the addition results at step S560.

Meanwhile, when the final operation is determined at step S570, the mantissa processing unit 300 normalizes mantissa computation results in the final computation result at step S580, and the mantissa processing unit 300 outputs a normalization value, generated as a result of the normalization, to the exponent processing unit 200 at step S590.

Here, since the detailed operation of the mantissa processing unit 300 for performing step S500 (mantissa computation) is identical to that described above with reference to FIGS. 1, 9, and 10, detailed descriptions thereof will be omitted.

As described above, the present invention is advantageous in that a conventional inefficient repetitive computation process attributable to Computing-in-Memory (CIM) for a mantissa part may be removed by processing computation by separating an exponent part and the mantissa part from each other, thus achieving a delay time of less than 2 cycles, with the result that processing speed may be remarkably improved compared to a conventional computation architecture having a delay time of 5000 or more cycles.

Further, the present invention is characterized in that it can not only reduce power consumption and speed reduction attributable to communication between an exponent processing unit and a mantissa processing unit by replacing a normalization process with preliminary normalization, but can also decrease consumption of space and power by mantissa computation units without decreasing computation precision by shortening the principal path of the mantissa computation units. For example, in the computation apparatus for DNN training, space and power consumption may be reduced on average by 10 to 20%, and in particular, in a system supporting brain floating-point multiplication and 32-bit floating-point accumulation for a ResNet-18 neural network, total power consumption by the computation units may be reduced by 14.4%, and total space consumption by the computation units may be reduced by 11.7%.

Further, the floating-point computation apparatus according to the present invention is characterized in that the amount of power required in order to access the exponent stored in memory may be greatly reduced owing to the reuse of charge by minimizing precharging of local bitlines and global bitlines. For example, in the computation apparatus for DNN training, total power consumption by memory may be reduced on average by 40 to 50%, and in particular, in a system supporting brain floating-point multiplication and 32-bit floating-point accumulation for the ResNet-18 neural network, total power consumption by memory may be reduced by 46.4%.

As described above, a floating-point computation apparatus and method using Computing-in-Memory (CIM) according to the present invention are advantageous in that numbers represented in a floating-point format may be calculated using CIM such that an exponent computation and a mantissa computation are separated from each other and such that only the exponent computation is performed by a CIM processor and the mantissa computation is performed by a mantissa processing unit, thus avoiding a processing delay occurring due to the use of Computing-in-Memory for the mantissa computation.

Further, the present invention is advantageous in that floating-point computation may be promptly performed by solving a processing delay occurring due to the need to use CIM for a mantissa computation, and the energy efficiency of a deep-neural network (DNN) accelerator may be improved by reducing the amount of power consumed by memory.

Furthermore, the present invention is advantageous in that only one local bitline may be precharged by supporting in-memory AND/NOR operations during the operation of a CIM processor, and charge may be reused if the previous value of a global bitline is identical to the current value of the global bitline by adopting a hierarchical bitline structure, thus minimizing precharging, with the result that the amount of power consumed in order to access an exponent stored in memory may be greatly reduced.

Furthermore, the present invention is advantageous in that sparsity patterns of input neurons that are input to a CIM processor and a mantissa processing unit may be derived, and thereafter computation on an input neuron, the sparsity pattern of which has a value of ‘0’, may be skipped, thus accelerating the entire DNN computation.

Furthermore, the present invention is advantageous in that a normalization process in an intermediate stage occurring during a mantissa computation process is skipped and normalization is performed only in a final stage, thereby reducing power consumption and speed reduction attributable to communication between a CIM processor for performing an exponent computation and a mantissa processing unit for performing a mantissa computation, and in that the principal path of the mantissa processing unit is shortened, thereby reducing consumption of space and power by the mantissa processing unit without decreasing computation precision.

Although the preferred embodiments of the present invention have been disclosed in the foregoing descriptions, those skilled in the art will appreciate that the present invention is not limited to the embodiments, and that various modifications, additions and substitutions are possible, without departing from the scope and spirit of the invention as disclosed in the accompanying claims.

What is claimed is:

1. A floating-point computation apparatus for performing a Multiply-and-Accumulation (MAC) operation on a plurality of pieces of input neuron data represented in a floating-point format, the floating-point computation apparatus comprising:
a data preprocessing unit configured to separate and extract an exponent and a mantissa from each of the pieces of input neuron data;
an exponent processing unit configured to perform Computing-in-Memory (CIM) on input neuron exponents, which are exponents separated and extracted from the pieces of input neuron data; and
a mantissa processing unit configured to perform a high-speed computation on input neuron mantissas, which are mantissas separated and extracted from the pieces of input neuron data,
wherein the exponent processing unit determines a mantissa shift size for a mantissa computation and transfers the mantissa shift size to the mantissa processing unit, and
wherein the mantissa processing unit normalizes a result of the mantissa computation and thereafter transfers a normalization value generated as a result of normalization to the exponent processing unit.

2. The floating-point computation apparatus of claim 1, wherein the data preprocessing unit is configured to:
generate at least one input neuron data pair by pairing two or more pieces of input neuron data that are sequentially input for a Multiply-and-Accumulate (MAC) operation depending on a sequence of the input neuron data,
separate and extract an exponent and a mantissa from each of arbitrary first and second input neuron data forming the input neuron data pair in each preset operation cycle, and
transfer first and second input neuron exponents, which are the separated and extracted exponents, to the exponent processing unit, and transfer first and second input neuron mantissas, which are the separated and extracted mantissas, to the mantissa processing unit.

3. The floating-point computation apparatus of claim 2, wherein the exponent processing unit comprises:
an input neuron exponent memory configured to sequentially store pairs of the first and second input neuron exponents that are transferred in each operation cycle;
an exponent computation memory configured to sequentially perform computing-in-memory on the first and second input neuron exponent pairs such that the computing-in-memory is performed in a bitwise manner and results of the computing-in-memory are output; and
an exponent peripheral circuit configured to sequentially calculate sums of the first and second input neuron exponent pairs from the results of the computing-in-memory transferred from the exponent computation memory, sequentially compare the sums of the first and second input neuron exponent pairs with each other, determine a difference between the sums to be the mantissa shift size, and update and store a maximum exponent value.

4. The floating-point computation apparatus of claim 3, wherein:
the exponent processing unit further comprises one or more exponent computation memories, and
the exponent peripheral circuit is shared by the one or more exponent computation memories.

5. The floating-point computation apparatus of claim 3, wherein each of the exponent computation memories comprises:
a plurality of computing-in-memory local arrays disposed in an a×b arrangement and configured to perform local computing-in-memory;
an input/output interface configured to provide an interface for reading and writing data from and to each of the plurality of computing-in-memory local arrays;
a global bitline and a global bitline bar configured to form a path through which results of local computing-in-memory for the plurality of computing-in-memory local arrays are moved to the exponent peripheral circuit; and
a wordline driver configured to generate a wordline driving signal to be transferred to the computing-in-memory local arrays.

6. The floating-point computation apparatus of claim 5, wherein each of the computing-in-memory local arrays comprises:
a local bitline and a local bitline bar in which the first input neuron exponent is precharged;
a precharger configured to precharge the local bitline and the local bitline bar based on a bit value of the first input neuron exponent;
a plurality of memory cells configured to store the second input neuron exponent in a bitwise manner, perform computing-in-memory on the second input neuron exponent and the first input neuron exponent precharged in the local bitline and the local bitline bar, and then determine bit values of the local bitline and the local bitline bar;
a first driver configured to drive the bit value of the local bitline to the global bitline in response to a global bitline enable signal that is input from an outside; and
a second driver configured to drive the bit value of the local bitline bar to the global bitline bar in response to the global bitline enable signal.

7. The floating-point computation apparatus of claim 6, wherein each of the memory cells is configured to:
operate in any one of a read mode and a write mode in response to the wordline driving signal,
in the write mode, store the second input neuron exponent transferred through the input/output interface in a bitwise manner,
in the read mode, perform computing-in-memory on the precharged first input neuron exponent and the second input neuron exponent, stored in a bitwise manner, and then determine the bit values of the local bitline and the local bitline bar, and
determine the bit value of the local bitline by performing an AND operation on the first input neuron exponent and the second input neuron exponent in a bitwise manner and determine the bit value of the local bitline bar by performing a NOR operation on the first input neuron exponent and the second input neuron exponent in a bitwise manner.

8. The floating-point computation apparatus of claim 7, wherein:
each of the exponent computation memories further comprises a decoder configured to analyze the first and second input neuron exponents that are targets of computing-in-memory and to control an operation to be performed by selecting a bitline in which the first input neuron exponent is to be charged and a memory cell in which the second input neuron exponent is to be stored, and
the decoder generates the global bitline enable signal.

9. The floating-point computation apparatus of claim 6, wherein each of the plurality of computing-in-memory local arrays is configured to sequentially perform:
a precharge process using the precharger,
a computing-in-memory process on each of the plurality of memory cells, and
a driving process using each of the first and second drivers,
wherein the processes are pipelined to overlap each other between adjacent computing-in-memory local arrays in such a way that a precharge process using an arbitrary n-th computing-in-memory local array, a computing-in-memory process using an (n+1)-th computing-in-memory local array, and a driving process using an (n+2)-th computing-in-memory local array are pipelined to overlap each other.

10. The floating-point computation apparatus of claim 5, wherein the exponent peripheral circuit comprises:
a plurality of exponent computation units connected in parallel to each other,
each of the exponent computation units comprises:
an exponent adder configured to receive, as inputs, the results of computing-in-memory transferred through the global bitline and the global bitline bar and calculate sums of the first and second input neuron exponent pairs; and
an exponent comparator configured to sequentially compare the sums of the first and second input neuron exponent pairs, received from the exponent adder in each operation cycle, with each other, determine a difference between the sums to be the mantissa shift size, and update and store a maximum exponent value.

11. The floating-point computation apparatus of claim 10, wherein the exponent comparator comprises:
a floating-point exception handler configured to receive the sums of the first and second input neuron exponent pairs from the exponent adder and perform exception handling in floating-point multiplication;
a first register configured to store a maximum exponent value, which is a maximum value, among the sums of the first and second input neuron exponent pairs calculated during a period ranging to a previous operation cycle;
a subtractor configured to obtain a difference between a sum of the first and second input neuron exponent pairs output from the floating-point exception handler, and the maximum value stored in the first register; and
a comparator configured to update the maximum exponent value stored in the first register based on a result of subtraction by the subtractor, determine the mantissa shift size, and transfer the mantissa shift size to the mantissa processing unit,
wherein the first register is configured to determine a final exponent value by updating the maximum exponent value based on the normalization value transferred from the mantissa processing unit.

12. The floating-point computation apparatus of claim 2, wherein the mantissa processing unit further comprises:
an input neuron mantissa memory configured to sequentially store pairs of the first and second input neuron mantissas that are transferred in each operation cycle; and
a plurality of mantissa computation units connected in parallel to each other and configured to sequentially calculate the first and second input neuron mantissa pairs, normalize a final computation result, and transfer a normalization value, generated as a result of the normalization, to the exponent processing unit, thus allowing the exponent processing unit to determine a final exponent value.

13. The floating-point computation apparatus of claim 12, wherein the mantissa processing unit further comprises:
a weight mantissa memory configured to separate and separately store only a weight mantissa part, which is a mantissa part of the weight generated in the deep neural network training process; and
an output neuron mantissa memory configured to separate and separately store only an output neuron mantissa part, which is a mantissa part of output neuron data generated in the deep neural network training process,
wherein each of the mantissa computation units is configured to perform a high-speed computation on mantissas transferred from at least one of the input neuron mantissa memory, the weight mantissa memory, and the output neuron mantissa memory.

14. The floating-point computation apparatus of claim 12, wherein each of the mantissa computation units comprises:
a multiplier configured to perform multiplication on the first and second input neuron mantissa pairs and store a result of the multiplication;
a shifter configured to perform shifting on the result of the multiplication based on the mantissa shift size;
a mantissa adder configured to perform addition on one or more shifted multiplication results;
a counter configured to count a mantissa overflow generated as a result of the addition;
a second register configured to accumulate and store the result of the addition; and
a normalization processor configured to normalize the result of the mantissa computation.

15. The floating-point computation apparatus of claim 14, wherein:
the mantissa computation unit is configured to sequentially perform the mantissa computation on all of the first and second input neuron mantissa pairs stored in the input neuron mantissa memory,
the counter and the second register are configured to transfer a mantissa overflow and an accumulated and stored value of the addition result that are generated in an intermediate operation stage to the shifter so as to perform an operation in a subsequent stage, and to transfer the mantissa overflow and the addition result that are generated during a mantissa computation in a final stage to the normalization processor, and
the normalization processor is configured to perform normalization only on the mantissa overflow and the addition result that are generated during the mantissa computation in the final stage.

16. A floating-point computation method for performing a multiply-and-accumulation operation on a plurality of pieces of input neuron data represented in a floating-point format using a floating-point computation apparatus that includes an exponent processing unit for an exponent computation in the floating-point format and a mantissa processing unit for a mantissa computation in the floating point format, the floating-point computation method comprising:
a data preprocessing operation of separating and extracting an exponent and a mantissa from each of the pieces of input neuron data;
an exponent computation operation of performing, by the exponent processing unit, computing-in-memory (CIM) on input neuron exponents, which are exponents separated and extracted in the data preprocessing operation; and
a mantissa computation operation of performing, by the mantissa processing unit, a high-speed computation on input neuron mantissas, which are mantissas separated and extracted in the data preprocessing operation,
wherein the exponent computation operation comprises determining a mantissa shift size for the mantissa computation and transferring the mantissa shift size to the mantissa processing unit, and
wherein the mantissa computation operation comprises normalizing a result of the mantissa computation and thereafter transferring a normalization value generated as a result of normalization to the exponent processing unit.

17. The floating-point computation method of claim 16, wherein the data preprocessing operation comprises:
a data pair generation operation of generating at least one input neuron data pair by pairing two or more pieces of input neuron data that are sequentially received for a Multiply-and-Accumulate (MAC) operation;
an exponent/mantissa separation extraction operation of separating and extracting an exponent and a mantissa from each of arbitrary first and second input neuron data forming the input neuron data pair in each preset operation cycle; and
a data transfer operation of transferring first and second input neuron exponents, which are the separated and extracted exponents to the exponent processing unit, and transferring first and second input neuron mantissas, which are the separated and extracted mantissas, to the mantissa processing unit.

18. The floating-point computation method of claim 17, wherein the exponent computation operation comprises:
a computing-in-memory operation of sequentially calculating pairs of the first and second input neuron exponents transferred in each operation cycle such that computing-in-memory is performed in a bitwise manner and sums of the first and second input neuron exponent pairs are calculated;
a mantissa shift size determination operation of sequentially comparing the sums of the first and second input neuron exponent pairs that are sequentially calculated in the computing-in-memory operation with each other, determining a difference between the sums to be the mantissa shift size, and transferring the mantissa shift size to the mantissa processing unit;
a maximum exponent value determination operation of determining a larger one of the sums of the first and second input neuron exponent pairs generated as a result of the sequential comparison to be a maximum exponent value;
a repetition operation of repeatedly performing the operation of performing the computing-in-memory operation, the mantissa shift size determination operation, and the maximum exponent value determination operation until a normalization value is transferred from the mantissa processing unit; and
a final exponent determination operation of, when the normalization value is transferred from the mantissa processing unit, determining a final exponent value by updating the maximum exponent value based on the normalization value.

19. The floating-point computation method of claim 18, wherein the mantissa computation operation comprises:
a multiplication operation of sequentially calculating pairs of the first and second input neuron mantissas generated in each operation cycle such that multiplication on the first and second input neuron mantissa pairs is calculated;
a shift operation of performing shifting on a result of the multiplication based on the mantissa shift size;
an addition operation of performing addition on one or more shifted multiplication results;
a count operation of counting a mantissa overflow generated as a result of the addition;
an accumulation operation of accumulating and storing the result of the addition; and
a normalization operation of normalizing a result of the mantissa computation, and
wherein the mantissa computation is sequentially performed on all of the first and second input neuron mantissa pairs that are transferred in the data transfer operation.

20. The floating-point computation method of claim 19, wherein:
each of the multiplication operation, the shift operation, the addition operation, the count operation, and the accumulation operation is repeated until the mantissa computation is sequentially performed on all of the first and second input neuron mantissa pairs that are transferred in the data transfer operation,
the shift operation comprises performing preliminary normalization on the result of the multiplication based on a mantissa overflow and an accumulated and stored value for the result of the addition that are generated in an intermediate operation stage, and
the normalization operation is performed during a mantissa computation in a final stage, among mantissa computations on all of the first and second input neuron mantissa pairs that are transferred in the data transfer operation, and is performed to transfer a normalization value generated as a result of the normalization, to the exponent processing unit.
